(19) United States
(12) Patent Application Publication
(10) Pub. No.: US 2026/0243176 A1
(43) Pub. Date: Aug. 20, 2026

(54) LOW PRESSURE TURBINE SHAFT INSTALLATION TOOL

(71) Applicant: RTX Corporation, Farmington, CT (US)

(72) Inventor: Zachary E. Boucher, Lyman, ME (US)

(73) Assignee: RTX Corporation, Farmington, CT (US)

(21) Appl. No.: 19/053,703

(22) Filed: Feb. 14, 2025

(51) Int. Cl. F01D 25/28

(52) U.S. Cl. CPC F01D 25/285; F05D 2230/68; F05D 2260/31

(57) ABSTRACT

A low pressure turbine shaft installation tool including a disk having an inner diameter and an outer diameter; the disk has an upper surface with a lower surface opposite the upper surface; a set of disk through holes are arrayed about the disk; and at least one threaded fastener is associated with at least one of the disk through holes and the at least one threaded fastener in operative communication with the upper surface.

### BACKGROUND

The present disclosure is directed to the improved low pressure turbine shaft installation tool.

During assembly of the low pressure turbine, the low pressure turbine shaft is lowered into the second stage disk. In certain instances, the low pressure turbine shaft flange binds with tie rods of the second stage disk. Particularly, the low pressure turbine shaft flange includes thru holes that can create an interference fit with the tie rods, thus preventing the shaft from seating properly. Due to variation in manufacturing the flange thru holes, an interference fit between the tie rod outer diameter and the true position of the low pressure turbine shaft flange holes exists.

In order to urge the low pressure turbine further into place, rubber mallets are used to tap onto the flange and push the low pressure turbine shaft into place overcoming the resistance of the tie rod to flange holes interference fit.

### SUMMARY

In accordance with the present disclosure, there is provided a low pressure turbine shaft installation tool comprising a disk comprising an inner diameter and an outer diameter; the disk comprises an upper surface with a lower surface opposite the upper surface; a set of disk through holes are arrayed about the disk; and at least one threaded fastener associated with at least one of the disk through holes and the at least one threaded fastener in operative communication with the upper surface.

A further embodiment of any of the foregoing embodiments may additionally and/or alternatively include the set of disk through holes are arrayed to match a circular pattern of tie rods coupled with a second stage rotor hub.

A further embodiment of any of the foregoing embodiments may additionally and/or alternatively include the at least one threaded fastener is configured to couple with the disk and the at least one threaded fastener configured to rotatably thread onto a tie rod coupled with a second stage rotor hub.

A further embodiment of any of the foregoing embodiments may additionally and/or alternatively include the at least one threaded fastener corresponds with a pattern of tie rods coupled with a second stage rotor hub.

A further embodiment of any of the foregoing embodiments may additionally and/or alternatively include the at least one threaded fastener comprises nuts that are attached to the upper surface and configured as free-spinning elements capable of applying forces into the low pressure turbine shaft flange.

A further embodiment of any of the foregoing embodiments may additionally and/or alternatively include the at least one threaded fastener is configured to employ threads of tie rods to press a low pressure turbine shaft flange into contact with a second stage rotor hub.

A further embodiment of any of the foregoing embodiments may additionally and/or alternatively include the at least one threaded fastener is configured as separable from the disk and employable on various tie rods to press the low pressure turbine shaft installation tool onto a low pressure turbine shaft flange to close a gap between a second stage rotor hub and the low pressure turbine shaft flange.

In accordance with the present disclosure, there is provided a low pressure turbine shaft installation tool for assembling a low pressure turbine shaft assembly with a second stage rotor assembly comprising a disk comprising an inner diameter and an outer diameter; the disk comprises an upper surface with a lower surface opposite the upper surface; a set of disk through holes are arrayed about the disk; and at least one threaded fastener associated with at least one of the disk through holes and the at least one threaded fastener in operative communication with the upper surface.

A further embodiment of any of the foregoing embodiments may additionally and/or alternatively include the disk comprises multiple discrete sections.

A further embodiment of any of the foregoing embodiments may additionally and/or alternatively include the multiple discrete sections include two or more individual crescent shaped disks deployable about a tie rod bolt pattern of a second stage rotor hub of the second stage rotor assembly, the multiple discrete sections configured to press a low pressure turbine shaft flange of the low pressure turbine shaft assembly onto the second stage rotor hub.

A further embodiment of any of the foregoing embodiments may additionally and/or alternatively include the set of disk through holes are arrayed to match a circular pattern of tie rods coupled with a second stage rotor hub of the second stage rotor assembly.

A further embodiment of any of the foregoing embodiments may additionally and/or alternatively include the set of disk through holes are configured as at least one of discrete bores and/or elliptical slots configured to receive at least one tie rod coupled with a second stage rotor hub of the second stage rotor assembly.

A further embodiment of any of the foregoing embodiments may additionally and/or alternatively include the at least one threaded fastener is configured as separable from the disk and employable on various tie rods coupled to a second stage rotor hub associated with the second stage rotor assembly to press the low pressure turbine shaft installation tool onto a low pressure turbine shaft flange associated with the low pressure turbine shaft assembly to close a gap between the second stage rotor hub and the low pressure turbine shaft flange.

In accordance with the present disclosure, there is provided a process of forming a low pressure turbine shaft installation tool for assembling a low pressure turbine shaft assembly with a second stage rotor assembly comprising forming a disk comprising an inner diameter and an outer diameter; the disk comprises an upper surface with a lower surface opposite the upper surface; forming a set of disk through holes are arrayed about the disk; associating at least one threaded fastener with at least one of the disk through holes; and placing the at least one threaded fastener in operative communication with the upper surface.

A further embodiment of any of the foregoing embodiments may additionally and/or alternatively include the disk comprises multiple discrete sections.

A further embodiment of any of the foregoing embodiments may additionally and/or alternatively include the process further comprising arraying the set of disk through holes are to match a circular pattern of tie rods coupled with a second stage rotor hub of the second stage rotor assembly.

A further embodiment of any of the foregoing embodiments may additionally and/or alternatively include the process further comprising configuring the set of disk through holes as at least one of discrete bores and/or elliptical slots; and configuring the set of disk through holes to receive at least one tie rod coupled with a second stage rotor hub of the second stage rotor assembly.

A further embodiment of any of the foregoing embodiments may additionally and/or alternatively include the process further comprising configuring the at least one threaded fastener as separable from the disk, employing the at least one threaded fastener on various tie rods coupled to a second stage rotor hub associated with the second stage rotor assembly; pressing the low pressure turbine shaft installation tool onto a low pressure turbine shaft flange associated with the low pressure turbine shaft assembly; and closing a gap between the second stage rotor hub and the low pressure turbine shaft flange.

A further embodiment of any of the foregoing embodiments may additionally and/or alternatively include the process further comprising configuring the at least one threaded fastener as nuts that are attached to the upper surface; configuring the at least one threaded fastener as a free-spinning element; and applying forces onto the low pressure turbine shaft flange.

A further embodiment of any of the foregoing embodiments may additionally and/or alternatively include the process further comprising coupling the at least one threaded fastener with the disk; and configuring the at least one threaded fastener to rotatably thread onto a tie rod coupled with a second stage rotor hub associated with the second stage rotor assembly.

Other details of the low pressure turbine shaft installation tool are set forth in the following detailed description and the accompanying drawings wherein like reference numerals depict like elements.

### BRIEF DESCRIPTION OF THE DRAWINGS

The above and further advantages of this disclosure may be better understood by referring to the following description in conjunction with the accompanying drawings, in which like reference numerals indicate like elements and features in the various figures. Letters may be appended to reference numbers to distinguish from reference numbers for similar features and to indicate a correspondence to other features in the drawings. For clarity, not every element may be labeled in every figure. The drawings are not necessarily to scale, emphasis instead being placed upon illustrating the principles of the disclosure.

FIG. 1 is an exploded view schematic representation of an exemplary low pressure turbine shaft assembly installation employing a low pressure turbine shaft installation tool.

FIG. 2 is an enlarged view schematic representation of the exemplary low pressure turbine shaft installation tool of FIG. 1.

FIG. 3 is a schematic representation of the exemplary low pressure turbine shaft installation tool prior to installation with the low pressure turbine shaft assembly.

FIG. 4 is a schematic representation of the exemplary low pressure turbine shaft installation tool with the low pressure turbine shaft flange.

FIG. 5 is a schematic representation of the exemplary low pressure turbine shaft installation tool with the low pressure turbine shaft flange and tie rods.

FIG. 6 is a schematic representation of the exemplary low pressure turbine shaft installation tool with the low pressure turbine shaft flange and tie rods.

### DETAILED DESCRIPTION

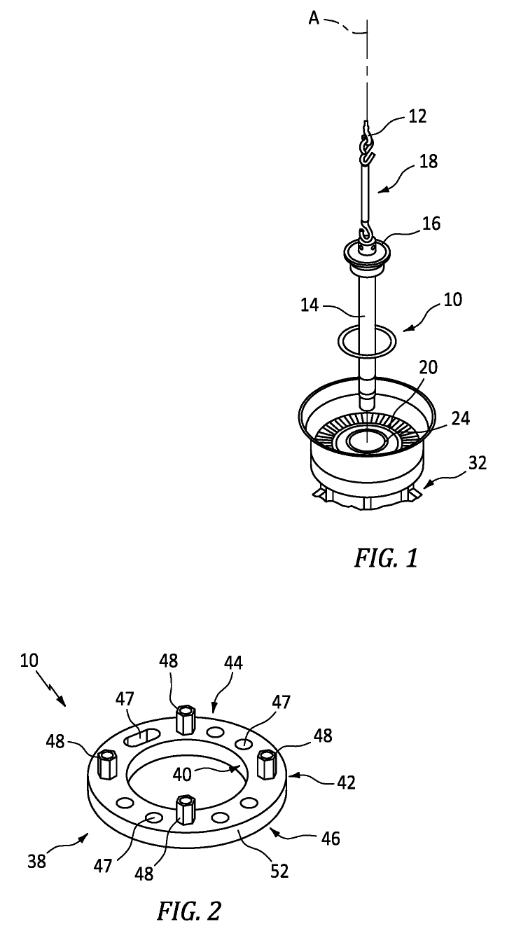

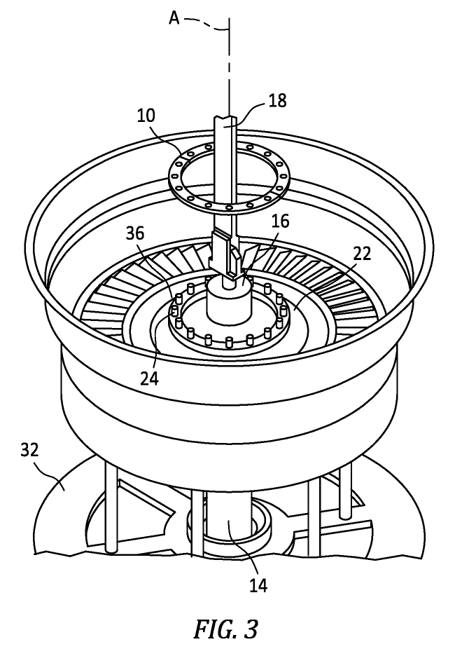

Referring now to FIG. 1, FIG. 2 and FIG. 3, the exemplary low pressure turbine shaft installation tool 10 is shown being installed. A hoist 12 is employed to lower the low pressure turbine shaft assembly 14. The hoist 12 connects to the low pressure turbine shaft assembly 14 with a coupling 16 and linkages 18 between the hoist 12 and coupling 16. The low pressure turbine shaft assembly 14 can be lowered into the second stage rotor assembly 20 proximate an aft end 22.

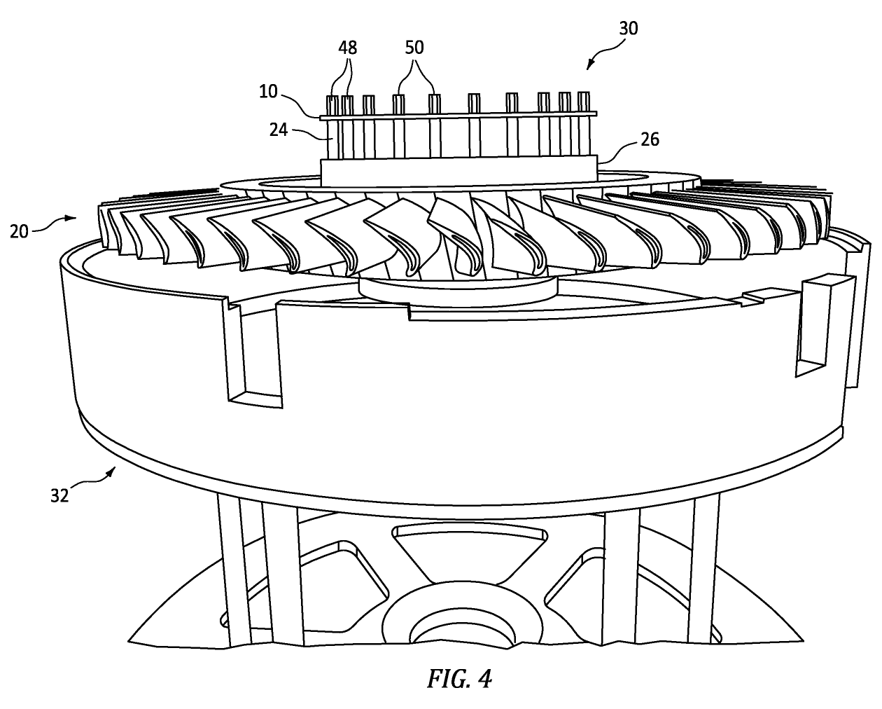

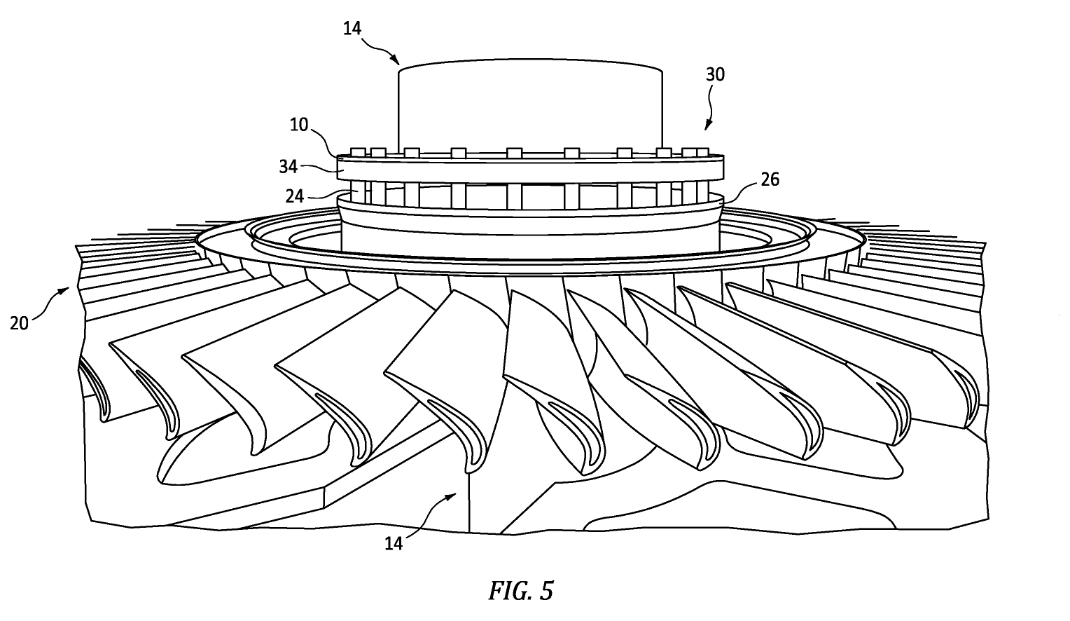

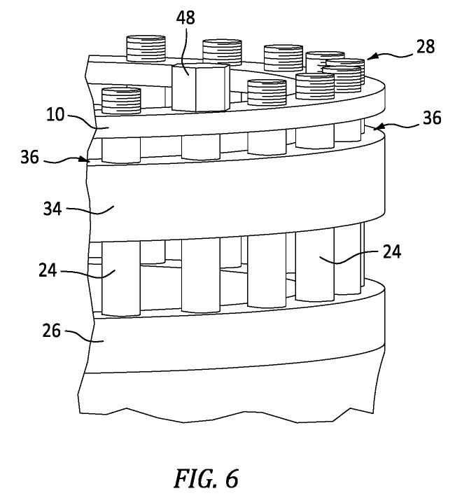

Referring also to FIG. 4, Fig, 5 and FIG. 6, the second stage rotor assembly 20 includes tie rods 24 arrayed about a second stage rotor hub 26. The tie rods 24 extend from the second stage rotor hub 26 axially relative to the axis A of the low pressure turbine shaft assembly 14 and second stage rotor assembly 20. The tie rods 24 include threads 28. In an exemplary embodiment, there can be multiple tie rods 24 arrayed about the second stage rotor hub 26 in a circular pattern 30.

The second stage rotor assembly 20 can be mounted on a build stand 32. The build stand 32 can support the second stage rotor assembly 20 and the lower pressure turbine shaft assembly 14 during installation.

The low pressure turbine shaft assembly 14 can include a low pressure turbine shaft flange 34. The low pressure turbine shaft flange 34 can be configured to couple with the second stage rotor hub 26. The low pressure turbine shaft flange 34 can include multiple through holes/ bore 36 arrayed about the low pressure turbine shaft flange 34 corresponding to the pattern of the tie rods 24 associated with the second stage rotor hub 26. The bores 36 can be configured to receive the corresponding tie rod 24 and allow for the tie rod 24 to pass through the bore 36 and expose the threads 28 for assembly of the low pressure turbine shaft assembly 14 with the second stage rotor assembly 20. The quantity and location of the bores 36 are dependent upon the bolt pattern of the tie rods 24.

The low pressure turbine shaft installation tool 10 can be configured as a disk 38 with an inner diameter 40 and outer diameter 42. The low pressure turbine shaft installation tool 10 can include an upper surface 44 with a lower surface 46 opposite the upper surface 44. A set of disk through holes 47 can be arrayed about the disk 38 to match the circular pattern 30 of the tie rods 24. The through holes 47 can be configured as discrete bores and/or elliptical slots configured to receive at least one of the tie rods 24. A set of threaded fasteners 48 can be associated with some or all of the disk through holes 47 and are in operative communication with the upper surface 44. The threaded fasteners 48 can be coupled with the disk 38 and configured to rotate. The threaded fasteners 48 can correspond with the tie rods 24 and match the pattern of the tie rods 24. The threaded fasteners 48 can include nuts 50 that are attached to the upper surface 44 and configured as free-spinning nuts capable of applying forces into the low pressure turbine shaft flange 34. The threaded fasteners 48 are configured to employ the threads 28 of the tie rods 24 to press the low pressure turbine shaft flange 34 into contact with the second stage rotor hub 26. The low pressure turbine shaft installation tool 10 can employ the threaded fasteners 48 to overcome any interferences between the tie rod 24 outer diameters and the bores 36 of the flange 34.

FIG. 2 shows four threaded fasteners 48 arrayed opposite and spaced evenly about the upper surface 44. The threaded fasteners 48 can be tightened in a sequence to evenly press the low pressure turbine shaft installation tool onto the low pressure turbine shaft flange 34. It is contemplated that multiple threaded fasteners 48 can be employed with the low pressure turbine shaft installation tool 10. It is contemplated that the threaded fasteners 48 can be separate from the disk 38 and used on various tie rods 24 to press the low pressure turbine shaft installation tool 10 onto the low pressure turbine shaft flange 34 to close the gap between the second stage rotor hub 26 and the low pressure turbine shaft flange 34.

It is also contemplated that the low pressure turbine shaft installation tool 10 can be formed from multiple discrete sections to form the disk 38, such as by forming two or more individual crescent shaped disks 38 that can include the threaded fasteners 48 and be employed about the tie rod 24 bolt pattern, to press the low pressure turbine shaft flange 34 onto the second stage rotor hub 26.

In an exemplary process for assembling the low pressure turbine shaft assembly 14 onto the second stage rotor assembly 20 can include lowering the second stage rotor assembly 20 onto the build stand 32. The low pressure turbine shaft assembly 14 can then be lowered into the second stage rotor assembly 20. The low pressure turbine shaft flange 34 passes over the tie rods 24 extending from the second stage rotor hub 26. The bores 36 formed in the low pressure turbine shaft flange 34 can receive the tie rods 24 associated with each bore 36. In certain circumstances some of the tie rods 24 can bind or interference fit with some of the bores 36. The low pressure turbine shaft installation tool 10 can be fitted over the low pressure turbine shaft flange 34. The through holes 47 of the low pressure turbine shaft installation tool 10 can receive the tie rods 24 associated with each through hole 47. The tie rods 24 can then pass through the through holes 47 as the low pressure turbine shaft installation tool 10 is lowered. The tie rods 24 can stand proud above the upper surface of the disk 38 of the low pressure turbine shaft installation tool 10. The threaded fasteners 48 can be tightened onto the threads 28 of the tie rods 24. As the threaded fasteners 48 are tightened, the low pressure turbine shaft installation tool 10 presses down onto the low pressure turbine shaft flange 34 and advances the low pressure turbine assembly 14 into a seated position. Ultimately, the low pressure turbine shaft flange 34 can come into contact with the second stage rotor hub 26 in a seated position. The threaded fasteners 48 can be untightened and removed from each of the associated tie rods 24. The low pressure turbine shaft installation tool 10 can be removed from the low pressure turbine shaft flange 34. The remainder of the installation of the low pressure turbine shaft assembly 14 with the second stage rotor assembly 20 can continue.

A technical advantage of the disclosed low pressure turbine shaft installation tool includes the capacity to overcome an interference fit between the low pressure turbine shaft flange and tie rods associated with the flange bores.

Another technical advantage of the disclosed low pressure turbine shaft installation tool includes the flexibility to employ threaded fasteners onto the tie rods to fully seat the low pressure turbine shaft flange into place.

Another technical advantage of the disclosed low pressure turbine shaft installation tool includes a low cost device that avoids contacting the low pressure turbine shaft flange with mallets to seat the assembly into place.

Another technical advantage of the disclosed low pressure turbine shaft installation tool includes flexibility to be employed in multiple parts with multiple threaded fasteners.

Another technical advantage of the disclosed low pressure turbine shaft installation tool includes an assembly process improvement in both EH&S and Quality.

There has been provided a low pressure turbine shaft installation tool. While the low pressure turbine shaft installation tool has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A low pressure turbine shaft installation tool comprising:
a disk comprising an inner diameter and an outer diameter; the disk comprises an upper surface with a lower surface opposite the upper surface;
a set of disk through holes are arrayed about the disk; and
at least one threaded fastener associated with at least one of the disk through holes and the at least one threaded fastener in operative communication with the upper surface.

2. The low pressure turbine shaft installation tool according to claim 1, wherein the set of disk through holes are arrayed to match a circular pattern of tie rods coupled with a second stage rotor hub.

3. The low pressure turbine shaft installation tool according to claim 1, wherein the at least one threaded fastener is configured to couple with the disk and the at least one threaded fastener configured to rotatably thread onto a tie rod coupled with a second stage rotor hub.

4. The low pressure turbine shaft installation tool according to claim 1, wherein the at least one threaded fastener corresponds with a pattern of tie rods coupled with a second stage rotor hub.

5. The low pressure turbine shaft installation tool according to claim 1, wherein the at least one threaded fastener comprises nuts that are attached to the upper surface and configured as free-spinning elements capable of applying forces into the low pressure turbine shaft flange.

6. The low pressure turbine shaft installation tool according to claim 1, wherein the at least one threaded fastener is configured to employ threads of tie rods to press a low pressure turbine shaft flange into contact with a second stage rotor hub.

7. The low pressure turbine shaft installation tool according to claim 1, wherein the at least one threaded fastener is configured as separable from the disk and employable on various tie rods to press the low pressure turbine shaft installation tool onto a low pressure turbine shaft flange to close a gap between a second stage rotor hub and the low pressure turbine shaft flange.

8. A low pressure turbine shaft installation tool for assembling a low pressure turbine shaft assembly with a second stage rotor assembly comprising:
a disk comprising an inner diameter and an outer diameter; the disk comprises an upper surface with a lower surface opposite the upper surface;
a set of disk through holes are arrayed about the disk; and
at least one threaded fastener associated with at least one of the disk through holes and the at least one threaded fastener in operative communication with the upper surface.

9. The low pressure turbine shaft installation tool according to claim 8, wherein the disk comprises multiple discrete sections.

10. The low pressure turbine shaft installation tool according to claim 9, wherein the multiple discrete sections include two or more individual crescent shaped disks deployable about a tie rod bolt pattern of a second stage rotor hub of the second stage rotor assembly, the multiple discrete sections configured to press a low pressure turbine shaft flange of the low pressure turbine shaft assembly onto the second stage rotor hub.

11. The low pressure turbine shaft installation tool according to claim 8, wherein the set of disk through holes are arrayed to match a circular pattern of tie rods coupled with a second stage rotor hub of the second stage rotor assembly.

12. The low pressure turbine shaft installation tool according to claim 8, wherein the set of disk through holes are configured as at least one of discrete bores and/or elliptical slots configured to receive at least one tie rod coupled with a second stage rotor hub of the second stage rotor assembly.

13. The low pressure turbine shaft installation tool according to claim 8, wherein the at least one threaded fastener is configured as separable from the disk and employable on various tie rods coupled to a second stage rotor hub associated with the second stage rotor assembly to press the low pressure turbine shaft installation tool onto a low pressure turbine shaft flange associated with the low pressure turbine shaft assembly to close a gap between the second stage rotor hub and the low pressure turbine shaft flange.

14. A process of forming a low pressure turbine shaft installation tool for assembling a low pressure turbine shaft assembly with a second stage rotor assembly comprising:
forming a disk comprising an inner diameter and an outer diameter; the disk comprises an upper surface with a lower surface opposite the upper surface;
forming a set of disk through holes are arrayed about the disk;
associating at least one threaded fastener with at least one of the disk through holes; and
placing the at least one threaded fastener in operative communication with the upper surface.

15. The process of claim 14, wherein the disk comprises multiple discrete sections.

16. The process of claim 14, further comprising:
arraying the set of disk through holes are to match a circular pattern of tie rods coupled with a second stage rotor hub of the second stage rotor assembly.

17. The process of claim 14, further comprising:
configuring the set of disk through holes as at least one of discrete bores and/or elliptical slots; and
configuring the set of disk through holes to receive at least one tie rod coupled with a second stage rotor hub of the second stage rotor assembly.

18. The process of claim 14, further comprising:
configuring the at least one threaded fastener as separable from the disk,
employing the at least one threaded fastener on various tie rods coupled to a second stage rotor hub associated with the second stage rotor assembly;
pressing the low pressure turbine shaft installation tool onto a low pressure turbine shaft flange associated with the low pressure turbine shaft assembly; and
closing a gap between the second stage rotor hub and the low pressure turbine shaft flange.

19. The process of claim 14, further comprising:
configuring the at least one threaded fastener as nuts that are attached to the upper surface;
configuring the at least one threaded fastener as a free-spinning element; and
applying forces onto the low pressure turbine shaft flange.

20. The process of claim 14, further comprising:
coupling the at least one threaded fastener with the disk; and
configuring the at least one threaded fastener to rotatably thread onto a tie rod coupled with a second stage rotor hub associated with the second stage rotor assembly.
